(19) United States
(12) Patent Application Publication
(10) Pub. No.: US 2011/0234060 A1
(43) Pub. Date: Sep. 29, 2011

(54) FIXING MECHANISM FOR STORAGE DEVICE

(75) Inventors: HUNG-YI WU, Tu-Cheng (TW); LEI LIU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/879,166

(22) Filed: Sep. 10, 2010

(30) Foreign Application Priority Data
Mar. 26, 2010 (CN) 201010133267.X

(51) Int. Cl. F16B 12/00

(52) U.S. Cl. 312/111

(57) ABSTRACT

A fixing mechanism for selectively fixing a first storage device and a second storage device includes a container member and a frame. The second storage device is a different size than the first storage device. The container member includes a bottom wall, a first sidewall positioned at a side of the bottom wall and a second sidewall positioned at the other side of the bottom wall. The sidewall forms a slide rail. The frame is positioned in the container member. The frame includes an engaging portion supporting the slide rail. The engaging portion is positioned in a first position for fixing the first storage device in a first state and positioned in a second position for fixing the second storage device in a second state.

### BACKGROUND

1. Technical Field

The present disclosure relates to a fixing mechanism for a storage device.

2. Description of the Related Art

Storage devices, such as hard disk drives, often require fixing mechanisms to be mounted in a computer. However, commonly used fixing mechanisms often accommodate a single device type only, resulting in problems if storage devices of different sizes are deployed.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the views, and both the views are schematic.

FIG. 1 is an isometric view of an embodiment of a fixing mechanism together with a first storage device.

FIG. 2 is an exploded, isometric view of the fixing mechanism and the first storage device shown in FIG. 1.

FIG. 3 is an isometric view of the fixing mechanism shown in FIG. 1 together with a second storage device.

FIG. 4 is an exploded, isometric view of the fixing mechanism and the second storage device shown in FIG. 3.

### DETAILED DESCRIPTION

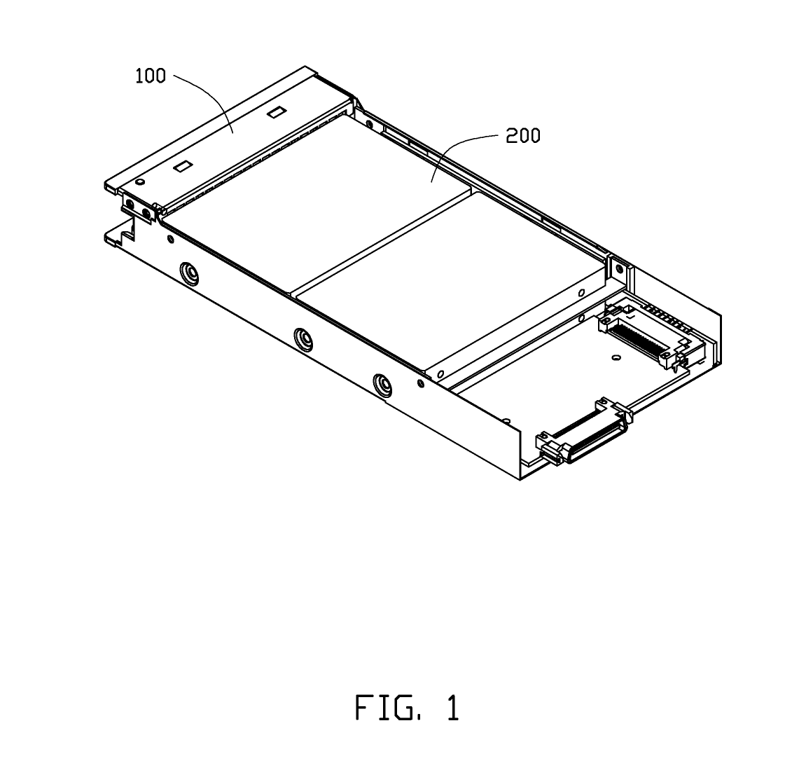

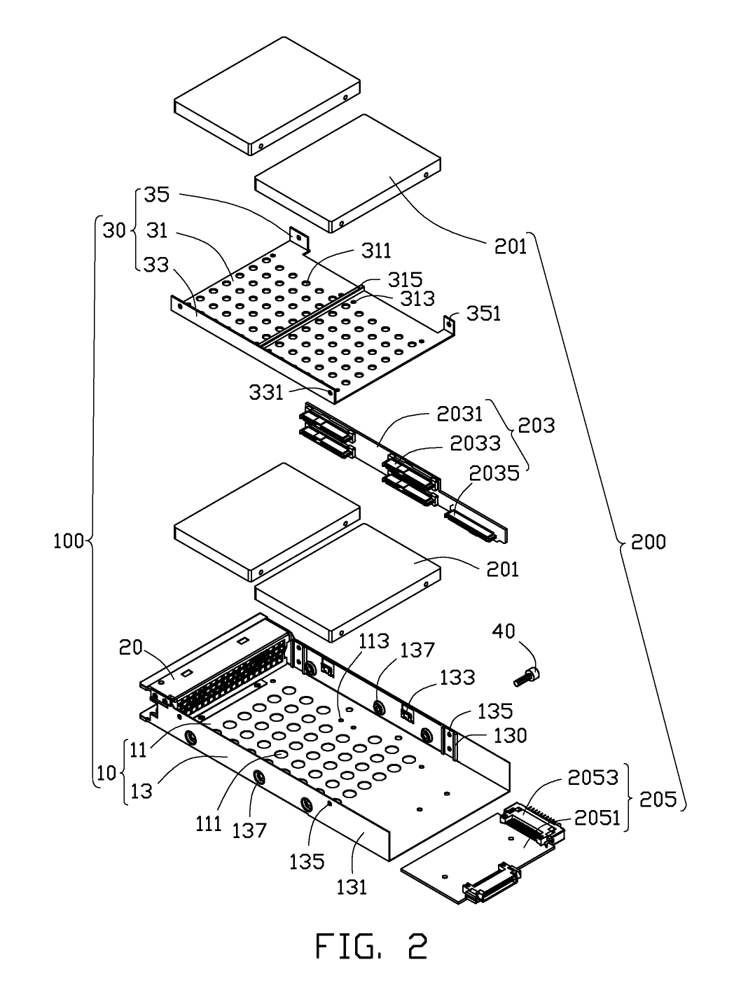

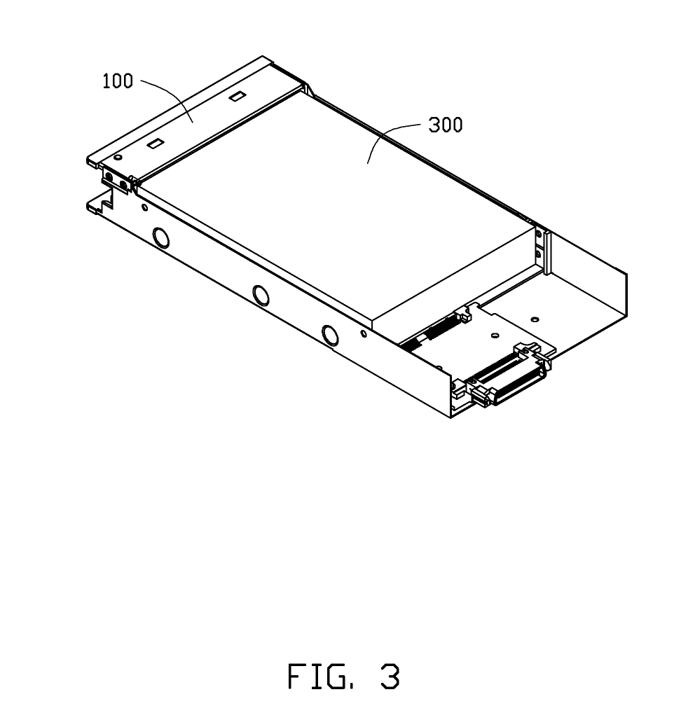

Referring to FIGS. 1 and 2, an exemplary embodiment of a fixing mechanism 100 is used for selectively containing a first storage device 200 or a second storage device 300 (shown in FIG. 3), in which the second storage device 300 has a size different from that of the first storage device 200. In the illustrated embodiment, each of the first storage device 200 and the second storage device 300 may be a hard disk drive.

As shown in FIG. 2, the fixing mechanism 100 for the storage device includes a container member 10, a connecting member 20 positioned at an end of the container member 10, and a frame 30. The connecting member 20 is used for mounting the fixing mechanism 100 in a computer or a server (not shown). The frame 30 can be accommodated in the container member 10.

The container member 10 includes a rectangular bottom wall 11, a first sidewall 130 and a second sidewall 131. The first sidewall 130 and the second sidewall 131 are extended from opposite sides of the bottom wall 11, respectively. The bottom wall 11 defines a plurality of cooling holes 111 and fixing holes 113. The first sidewall 130 forms two pairs of slide rails 131 and two elastic members 133. The first sidewall 130 defines two first fixing holes 135 disposed between each pair of slide rails 131 of the first sidewall 130, and defines three second fixing holes 137 disposed between two pairs of slide rails 131. The elastic members 133 on the first sidewall 130 are bulged out from the main body of the first sidewall 130 towards the second sidewall 131. The second sidewall 131 defines two first fixing holes 135 corresponding to the first fixing holes 135 of the first sidewall 130, and three second fixing holes 137 corresponding to three second fixing holes 137 of the first sidewall 130.

The frame 30 includes a bottom plate 31, a side plate 33 extending from a side of the bottom plate 31. The bottom plate 31 forms a pair of engaging portions 35 particularly extending from the other side of the bottom plate 31 and being opposite to the side plate 33. The bottom plate 31 defines a plurality of cooling holes 311 and positioning holes 313. The bottom plate 31 forms a positioning rib 315 thereon. The side plate 33 defines two fixing holes 331 corresponding to the first fixing holes 135 of the second sidewall 131. Each engaging portion 35 forms a fixing structure 351. In the illustrated embodiment, the fixing structure 351 is a through hole corresponding to the first fixing hole 135 of the container member 13. Alternatively, the fixing structure 351 may be implemented by a hook, and accordingly there are locking structures, such as hooking holes or mounting slots, between the slide rails 131 of the sidewalls 13.

Furthermore, the first storage device 200 includes a plurality of storage members 201, a first adapter card 203 and a second adapter card 205. Each first storage member 201 defines an interface (not shown) at a side surface and a plurality of threaded holes (not shown) at a bottom surface. The first adapter card 203 includes a first circuit board 2031, a plurality of connectors 2033 on the first circuit board 2031 for the first storage member 201, and an adapter 2035. The second adapter card 205 includes a second circuit board 2051 and two receptacles 2053 at adjacent edges of the second circuit board 2051. In the illustrated embodiment, the size of the first storage member 201 is 2.5 inches; and a total of four first storage members 201 are deployed. The connector 2033 on the first adapter card 203 is arranged in order, and has a total quantity of four. The connector 2033 and the adapter 2035 are both SAS (Serial Attached SCSI) male connector, suitable for hard disks utilizing SAS and SATA (Serial Advanced Technology Attachment) connectors. The two receptors 2053 are female connectors.

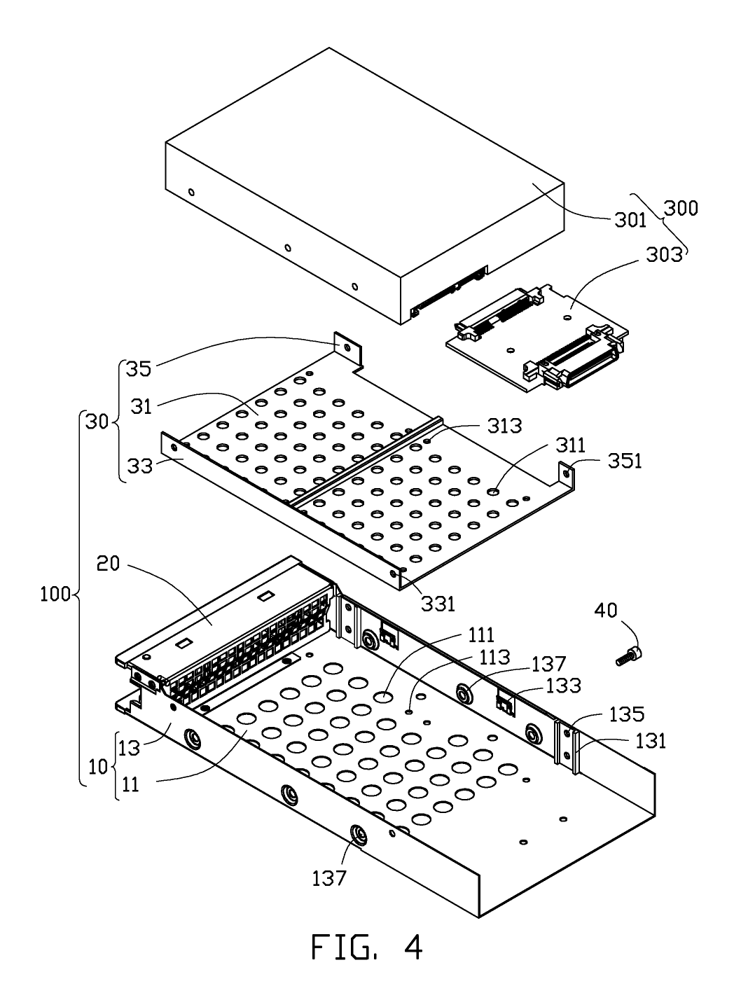

FIGS. 3 and 4 show a second storage device 300, differing from the first storage device 200 only in the inclusion of a 3.5 inch storage member and only one first adapter card 303.

In use, when the fixing mechanism 100 is adopted for fixing the first storage device 200, the four storage members 201 are connected to the connectors 2033 of the first adapter card 203, respectively. The positioning rib 315 of the frame 30 is between two adjacent storage members 201, and the engaging portions 35 of the frame 30 are adjacent to the first adapter card 203. The adapter 2035 of the first adapter card 203 is plugged in the receptacle 2053 of the second adapter card 205. The first storage device 200 and the frame 30 are positioned in the container member 10, and the engaging portion 35 of the frame 30 is engaged in the slide rail 131 of the container member 10. A fastener 40 passes through the first fixing hole 135 of the container member 10 and is threaded in the fixing structure 351 of the engaging portion 35, in order to fix the frame 30 in the container member 10 in a first position for containing the first storage device 200. The elastic member 133 resists the first adapter card 203, preventing damage from movement thereof. The second adapter card 205 is electrically connected to a computer or server (not shown) by wires (not shown).

If the fixing mechanism 100 is adopted for fixing the second storage device 300, the second storage device 300 is fixed on the frame 30, and mounted in the container member 10. The fastener 40 passes through the second fixing hole 137 and is threaded in the storage member 301, to maintain the frame 30 in a second position for fixing the second storage device 300.

Finally, while particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. A fixing mechanism for selectively fixing a first storage device and a second storage device having a second size that is different from a first size of the first storage device, the fixing mechanism comprising:
a container member, the container member comprising a bottom wall, a first sidewall positioned at a side of the bottom wall and a second sidewall positioned at the other side of the bottom wall, wherein each of the first sidewall and the second sidewall forming a slide rail;
a frame positioned in the container member, the frame comprising a engaging portion supporting the slide rail, the engaging portion positioned in a first position for fixing the first storage device in a first state and positioned in a second position for fixing the second storage device in a second state.

2. The fixing mechanism of claim 1, wherein the engaging portion of the frame is formed at a side of the frame.

3. The fixing mechanism of claim 2, wherein the engaging portion of the frame comprises a fixing structure and the first and second sidewalls each defines a first fixing hole corresponding to the fixing structure, through which a fastener passes and is received in the fixing structure, to fix the frame in the container member.

4. The fixing mechanism of claim 3, wherein the fixing structure is a through hole.

5. The fixing mechanism of claim 1, wherein the first sidewall forms an elastic member resisting the first storage device or the second storage device.
